(19) United States
(12) Patent Application Publication
(10) Pub. No.: US 2012/0268025 A1
(43) Pub. Date: Oct. 25, 2012

(54) SWITCHING CIRCUIT SYSTEM FOR ADJUSTING BRIGHTNESS AND METHOD THEREOF

(75) Inventors: DER-HO CHI, Tu-Cheng (TW); YANG-JUI CHAO, Tu-Cheng (TW); ZHI-QIANG XIE, Shenzhen City (CN); JI-BAO FU, Shenzhen City (CN); WEN-TAO WU, Shenzhen City (CN); MI TANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/187,519

(22) Filed: Jul. 21, 2011

(30) Foreign Application Priority Data
Apr. 22, 2011 (CN) 201110101387.6

(51) Int. Cl. H05B 37/02

(52) U.S. Cl. 315/201

(57) ABSTRACT

A switching circuit system includes a rectification circuit, a transformer, a light-emitting unit, a touch panel including a plurality of touch sensors, and a central processing unit (CPU). The CPU determines that a first user operation is taken place on the touch panel when first and second touch signals from at least two touch sensors have been received within a predetermined time interval, and further determines the track of the touches according to the sequence in which the first and second touch signals were received when the first user operation was determined. The CPU further directs the transformer to control the voltage output to the light-emitting unit according to the determined touch track to control the switching circuit system to execute a first function, and otherwise, a second user operation is determined which executes a second function. A related method is also provided.

### BACKGROUND

1. Technical Field

The present disclosure relates to switching circuits and, particularly, to a switching circuit system capable of adjusting the brightness of a light-emitting unit and a method thereof.

2. Description of the Related Art

Mechanical switches are widely employed to control light-emitting diode (LED) lamps, for example, turning them on or off and adjusting the brightness. However, mechanical switches may become unreliable after repeated use.

Therefore, there is room for improvement within the art.

### BRIEF DESCRIPTION OF THE DRAWINGS

The components in the drawings are not necessarily drawn to scale, the emphasis instead being placed upon clearly illustrating the principles of a switching circuit system for adjusting the brightness of LED lamps and a method thereof. Moreover, in the drawings, like reference numerals designate corresponding parts throughout the several views.

FIG. 1 is a block diagram of a switching circuit system in accordance with an exemplary embodiment.

FIG. 2 is a flowchart of a method for adjusting the brightness of a light-emitting unit by means of the switching circuit system of FIG. 1 in accordance with an exemplary embodiment.

### DETAILED DESCRIPTION

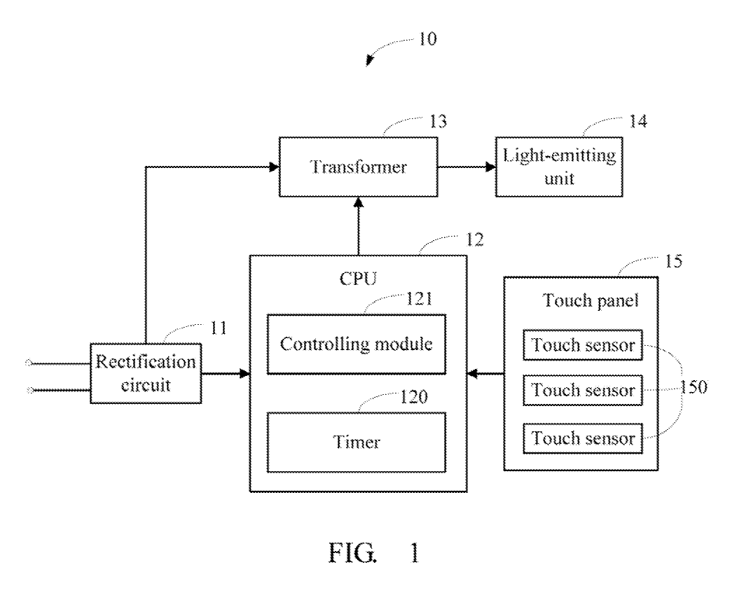

Referring to FIG. 1, a switching circuit system 10 includes a rectification circuit 11, a CPU 12, a transformer 13 connected to the rectification circuit 11 and the CPU 12, and a light-emitting unit 14 connected to the transformer 13. In the embodiment, the light-emitting unit 14 includes a number of light emitting diodes (LEDs). The rectification circuit 11 is configured to convert an alternating current (AC) power supply to a direct current (DC) regulated power supply, to supply voltage to the switching circuit system 10.

The switching circuit system 10 further includes a touch panel 15 connected to the CPU 12. The touch panel 15 includes a plurality of touch sensors 150, and each of the touch sensors corresponds to a particular location on the touch panel 15. When one touch sensor 150 is touched, that touch sensor 150 generates a signal.

The CPU 12 determines whether the signals from at least two touch sensors 150 have been received within a predetermined time interval. The CPU 12 includes a timer 120 and a controlling module 121. When the controlling module 121 receives a signal from one touch sensor 150, the controlling module 121 directs the timer 120 to begin recording. If the controlling module 121 determines that a second signal from another touch sensor 150 is received before the lapse of a predetermined time interval, the controlling module 121 determines that a first user operation has taken place on the touch panel 15. If the second signal is received after the lapse of the predetermined time interval or no second signal is received after the lapse of the predetermined time interval, the controlling module 121 determines that a second user operation is exerted on the touch panel 15. In the embodiment, the first user operation is a moving or sliding contact on the touch panel, and the second user operation is a tapping or clicking on the touch panel.

When the controlling module 121 determines that the first user operation has taken place on the touch panel 15, the controlling module 121 determines a touch track according to the sequence in which the touch signals were received. The controlling module 121 further directs the transformer 13 to change the value of the voltage output to the light-emitting unit 14 according to the determined touch track to control the switching circuit system 10 to execute a first function. In the embodiment, the first function is used to adjust the brightness of the light-emitting unit 14. In detail, a fingertip or other tool sliding from the top to the bottom of the touch panel 15 is used to gradually increase the brightness of the light-emitting unit 14, and a sliding in the reverse direction is used to gradually decrease the brightness of the light-emitting unit 14. In an alternative embodiment, the first function is used to cause the light-emitting unit 14 to flash on and off at a predetermined frequency.

When the controlling module 121 determines that the second user operation has taken place on the touch panel 15, the controlling module 121 directs the transformer 13 to control the voltage output to the light-emitting unit 14 according to the second user operation and controls the switching circuit system 10 to execute a second function. In the embodiment, the second function is used to turn off or turn on the light-emitting unit 14. In detail, a single click is used to turn on the light-emitting unit 14, and a double click is used to turn off the light-emitting unit 14.

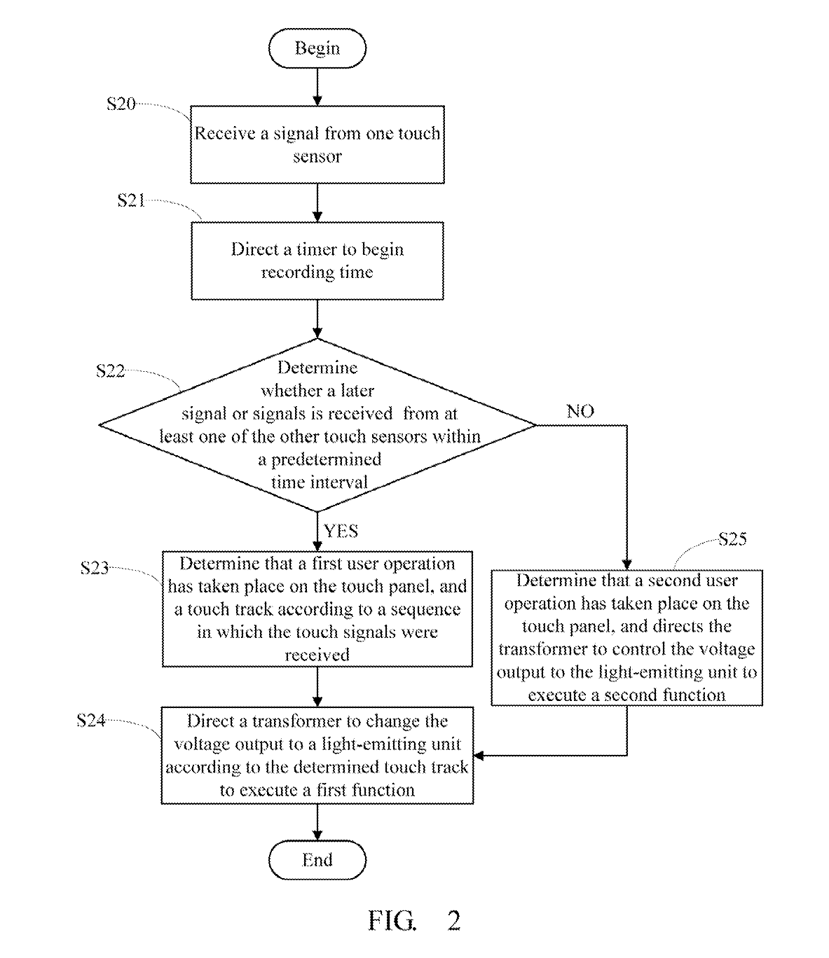

FIG. 2 is a flowchart of a method for adjusting the brightness of the system 10 of FIG. 1 in accordance with an exemplary embodiment.

In step S20, the controlling module 121 receives a signal from one touch sensor 150.

In step S21, the controlling module 121 directs the timer 120 to begin recording time.

In step S22, the controlling module 121 determines whether a later signal or signals is received from at least one of the other touch sensors 150 within a predetermined time interval. If yes, the process goes to step S23, otherwise, the process goes to step S25.

In step S23, the controlling module 121 determines that a first user operation has taken place on the touch panel 15, and further determines the touch track on the touch panel 15 according to the sequence in which the touch signals were received.

In step S24, the controlling module 121 directs the transformer 13 to change the value of the voltage output to the light-emitting unit 14 according to the determined touch track to control the switching circuit system 10 to execute the first function.

In the embodiment, the first function is used to adjust the brightness of the light-emitting unit 14. In detail, a fingertip or other tool sliding from the top to the bottom of the touch panel 15 is used to gradually increase the brightness of the light-emitting unit 14, and a sliding in the reverse direction is used to gradually decrease the brightness of the light-emitting unit 14. In an alternative embodiment, the first function is used to cause the light-emitting unit 14 to flash on and off at a predetermined frequency.

In step S25, the controlling module 121 determines that the second user operation has taken place on the touch panel 15, and further directs the transformer 13 to control the voltage output to the light-emitting unit 14 to control the switching circuit system 10 to execute the second function.

In the embodiment, the second function is used to turn off or turn on the light-emitting unit 14. In detail, a single click is used to turn on the light-emitting unit 14, and a double click is used to turn off the light-emitting unit 14.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A switching circuit system comprising:
a rectification circuit configured to convert an alternating current power supply to a direct current regulated power supply to supply voltage to the switching circuit system;
a transformer connected to the rectification circuit;
a light-emitting unit connected to the transformer;
a touch panel comprising a plurality of touch sensors, each of the touch sensors corresponding to a particular location on the touch panel, and generating a signal in response to user touch; and
a central processing unit (CPU) configured to determine that a first user operation is taken place on the touch panel when first and second touch signals from at least two touch sensors have been received within a predetermined time interval, and further determine a touch track according to the sequence in which the first and second touch signals were received when a first user operation is determined, the CPU further configured to direct the transformer to change the value of the voltage output to the light-emitting unit according to the determined touch track to control the switching circuit system to execute a first function.

2. The switching circuit system as recited in claim 1, wherein the first function is to adjust the brightness of the light-emitting unit.

3. The switching circuit system as recited in claim 2, wherein the CPU directs the transformer to gradually increase the brightness of the light-emitting unit when the determined touch track is from a top to a bottom of the touch panel.

4. The switching circuit system as recited in claim 2, wherein the CPU directs the transformer to gradually decrease the brightness of the light-emitting unit when the determined touch track is from a bottom to a top of the touch panel.

5. The switching circuit system as recited in claim 1, wherein the first function is to control the light-emitting unit to flash on and off at a predetermined frequency.

6. The switching circuit system as recited in claim 1, wherein the CPU is further configured to determine that a second user operation is taken place on the touch panel when the second touch signal from a corresponding touch sensor or no second touch signal is received after the predetermined time interval, and directs the transformer to control the voltage output to the light-emitting unit according to the second user operation and controls switch circuit system to execute a second function.

7. The method as recited in claim 6, wherein the second function is to turn off or turn on the light-emitting unit.

8. The switching circuit system as recited in claim 7, wherein the CPU directs the transformer to turn on the light-emitting unit if the second user operation is a single click on the touch panel.

9. The switching circuit system as recited in claim 7, wherein the CPU directs the transformer to turn off the light-emitting unit if the second user operation is a double click on the touch panel.

10. The switching circuit system as recited in claim 1, wherein the light-emitting unit comprises a plurality of light-emitting diodes.

11. A method for adjusting brightness of a light-emitting unit applied in a switching circuit system, the switching circuit system comprising a touch panel, a central processing unit (CPU), a transformer, and the light-emitting unit, the touch panel comprising a plurality of touch sensors, each of the touch sensor corresponding to a touch spot of the touch panel and generating a touch signal in response to user touch, the method comprising:
determining that a first user operation is taken place on the touch panel when first and second touch signals from at least two touch sensors are received within a predetermined time interval;
determining a touch track on the touch panel according to the sequence in which the signals are received; and
directing the transformer to control the voltage output to the light-emitting unit to control the switching circuit system to execute a first function.

12. The method as recited in claim 11, wherein the first function is to adjust the brightness of the light-emitting unit.

13. The method as recited in claim 12, wherein the first function is to gradually increase the brightness of the light-emitting unit when the determined touch track is from a top to a bottom of the touch panel.

14. The method as recited in claim 12, wherein the first function is to gradually decrease the brightness of the light-emitting unit when the determined touch track is from a bottom to a top of the touch panel.

15. The method as recited in claim 11, wherein the first function is to control the light-emitting unit to flash on and off at a predetermined frequency.

16. The method as recited in claim 11, the method further comprising:
determining that a second user operation is taken place on the touch panel when the second touch signal or no second touch signal is received after the predetermined time interval; and
directing the transformer to control the voltage output to the light-emitting unit to control the switching circuit system to execute a second function.

17. The method as recited in claim 16, wherein the second function is to turn off or turn on the light-emitting unit.

18. The method as recited in claim 17, wherein the second function is to turn on the light-emitting unit if the second user operation is a single click on the touch panel.

19. The method as recited in claim 17, wherein the second function is to turn off the light-emitting unit if the second user operation is a double click on the touch panel.
